(19) United States
(12) Patent Application Publication
(10) Pub. No.: US 2019/0183234 A1
(43) Pub. Date: Jun. 20, 2019

(54) Smart Facial Hair Grooming Device

(71) Applicant: Linu Pandakasalayil Kurikesu, Brampton (CA)

(72) Inventor: Linu Pandakasalayil Kurikesu, Brampton (CA)

(21) Appl. No.: 16/326,232

(22) PCT Filed: Aug. 9, 2017
(86) PCT No.: PCT/IB17/54853

§ 371 Date: Feb. 18, 2019

Related U.S. Application Data
(60) Provisional application No. 62/376,621, filed on Aug. 18, 2016.

(51) Int. Cl. A45D 44/00; B26D 5/00; A45D 27/42; G05B 19/042

(52) U.S. Cl. CPC A45D 44/005; B26D 5/007; A45D 27/42; G05B 2219/25323; B26D 2005/002; G05B 2219/25257; G05B 19/042

(57) ABSTRACT

The present disclosure relates to an Artificial Intelligence (AI) enabled smart facial hair grooming device designed to groom, design, or shave facial hair automatically. Aspects of the present disclosure relate to a grooming device 100 capable of grooming, designing or shaving facial hair of a user, the grooming device 100 including a face shield 102 configured with a plurality of razors 108 installed on at least one inner surface of the face shield 102, at least one micro-controller configured to control movement of the plurality of razors 108, and an Artificial Intelligence (AI) based pixel identifier (PI) module configured to visualize a desired facial hair style on face of the user and program the micro-controller with or without additional motors to move each of the plurality of razors 108 in a desired direction to allow cutting of facial hair of the user as per the desired facial hair style.

### TECHNICAL FIELD

The present invention relates generally to the field of grooming devices, and more specifically, to an Artificial Intelligence (AI) enabled smart facial hair grooming device designed to groom, design, or shave facial hair automatically.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

Facial hair is a secondary sex characteristic of males, referring to the growth of hair on or around chin, jowls and philtrum. Male pogonotrophy (growing of facial hair) is often culturally associated with wisdom and virility. Men style their facial hair into beards, moustaches, goatees or sideburns while others shave off their facial hair completely. Those who enjoy having facial hair often spend a great deal of time and money styling the hair into intricate designs and patterns. Because facial hair grows out quickly, it can be expensive and time-consuming to keep their facial hair cut in these patterns by professionals, and it may be too difficult to maintain the patterns without professional assistance. Therefore, a need exists for a specially designed machine to do the work quickly and automatically.

Now-a-days, a large segment of population include people who are crippled, elderly, or incapacitated who cannot efficiently use grooming devices because of their cumbersome functioning and inefficient performance. Hence, there arises a need to provide for a safe and easy to operate grooming device that can automatically groom, design or shave facial hair of people who are crippled, elderly, or incapacitated, and can further create various facial hair styles for such people in a short time interval.

Till date many automatic grooming devices have been developed that provide automatic grooming to shave or design facial hair by providing a plurality of blades that move, rotate or oscillate by the action of a motor or any such rotary or oscillatory means controlled by a controller or an Integrated Chip (IC). However, such automatic grooming devices do not provide operability with either a mobile device or a host computer, wherein operations of the grooming devices can be controlled by the mobile device or the host computer. Thus, an improvement in the art of such automatic grooming devices is required that can improve ease of operability of such devices.

While various hair grooming devices have been developed which provide the convenience of designing, grooming and shaving of facial hair, none of such devices have been accepted or have been successful in the hair styling profession since they are cumbersome to manipulate and do not adequately perform their desired functions.

There is therefore a need in the art of grooming devices that can provide the convenience of designing, grooming and shaving of facial hair, and can create various facial hair styles for men in a short time interval. Additionally, there exists a need to provide for an Artificial Intelligence (AI) enabled grooming device that performs various grooming operations automatically by evaluating facial contours and shapes, and eliminates deficiencies of known grooming devices.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

### OBJECTS OF THE INVENTION

It is an object of the present disclosure to provide an Artificial Intelligence (AI) enabled grooming device.

It is another object of the present disclosure to provide a grooming device that is safe, easy to operate and provides convenience to a user to select a desirable facial hair style from various facial hair styles.

It is another object of the present disclosure to provide a grooming device that can be efficiently used by crippled, elderly, or incapacitated.

It is another object of the present disclosure to provide a grooming device that can groom, design or shave complex facial hair pattern.

It is another object of the present disclosure to provide a grooming device that is water-resistant.

It is another object of the present disclosure to provide a grooming device that can be controlled by a mobile device or a host computer.

It is another object of the present disclosure to provide a grooming device that can enable grooming, designing or shaving of facial hair based on user's preference.

It is another object of the present disclosure to provide a grooming device that can create various facial hair styles for men in a short time interval.

It is another object of the present disclosure to provide a grooming device that is easy to use.

Yet another object of the present disclosure is to provide a grooming device that provides precise grooming or designing operations.

### SUMMARY

The present invention relates generally to the field of grooming devices, and more specifically, to an Artificial Intelligence (AI) enabled smart facial hair grooming device designed to groom, design, or shave facial hair automatically.

Aspects of the present disclosure relate to a grooming device capable of grooming, designing or shaving facial hair of a user, the grooming device including a face shield configured with a plurality of razors installed on at least one inner surface of the face shield, at least one micro-controller configured to control movement of the plurality of razors, and an Artificial Intelligence (AI) based pixel identifier (PI) module configured to visualize a desired facial hair style on face of the user and program the micro-controller to move each of the plurality of razors in a desired direction to allow cutting of facial hair of the user as per the desired facial hair style.

In an aspect, the plurality of razors have three dimensional moving ability and each of the plurality of razors include one or more nano-blades that have sharp edges to effect horizontal, vertical and angular cutting. In an aspect, the plurality of razors are mounted either on a movable platform or on a platform where the plurality of razors move in omni-direction either individually or in groups.

In an aspect, the at least one micro-controller enables magnetic levitation based movement of the plurality of razors. In an aspect, the at least one micro-controller is connected to blade nose of each of the plurality of razors or a single micro-controller can be configured to control movement of the plurality of razors.

In an aspect, the PI module is configured to calculate movement points for the plurality of razors to target, to enable pixel perfect movement of the plurality of razors, and the PI module detects facial hair shape, contours and hair pattern using AI algorithms and provides corresponding commands to the micro-controller to control movement of the plurality of razors.

In an aspect, the device includes a size adjustable frame that is hingedly connected to the face shield, and an adjusting knob that adjusts the size adjustable frame to enable proper fitting of the device on head of the user.

In an aspect, the device includes any or a combination of one or more sensors, imaging devices, motion sensors and ultrasonic sensors to scan face of a user in real-time before actuating movement of the plurality of razors by the micro-controller.

In an aspect, the device is controlled by a computing device. In another aspect, the device is configured with a default switch that triggers any or a combination of one or more sensors, imaging devices, motion sensors and ultrasonic sensors to detect presence of hair within the face shield. In an aspect, one touch of the default switch can further enable a user to execute a clean shave operation if the user is not equipped with a mobile device or a computing device, and is unable to choose a desired beard style.

In an aspect, the device includes a touch screen that displays various facial hair styles to the user and provides execution of grooming, designing or shaving operation of the desired style selected by the user.

It would be appreciated that although aspects of the present disclosure have been explained with respect to a grooming device capable of grooming, designing or shaving facial hair, the present disclosure is not limited to the same in any manner whatsoever and any other form of grooming devices is completely covered within the scope of the present disclosure.

Those skilled in the art will further appreciate the advantages and superior features of the disclosure together with other important aspects thereof on reading the detailed description that follows in conjunction with the drawings.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary representation of proposed grooming device in accordance to an embodiment of the present disclosure.

FIG. 2 illustrates an exemplary representation of retracted and extended position of a razor in accordance to an embodiment of the present disclosure.

FIGS. 3A and 3B illustrates exemplary rear and side views of the proposed grooming device in accordance to an embodiment of the present disclosure.

FIGS. 4A and 4B illustrate exemplary representation of the proposed grooming device installed on head of a user in an expanded state and a retracted state respectively in accordance to an embodiment of the present disclosure.

FIG. 5A illustrates an exemplary representation of unshaven beard of the user in accordance to an embodiment of the present disclosure.

FIG. 5B illustrates an exemplary representation of shaven beard of the user using the proposed grooming device in accordance to an embodiment of the present disclosure.

FIG. 6 illustrates an exemplary representation of a computing device configured to control the proposed grooming device in accordance to an embodiment of the present disclosure.

### DETAILED DESCRIPTION

If the specification states a component or feature “may”, “can”, “could”, or “might” be included or have a characteristic, that particular component or feature is not required to be included or have the characteristic.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any electronic code generator shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

Various terms as used herein are shown below. To the extent a term used in a claim is not defined below, it should be given the broadest definition persons in the pertinent art have given that term as reflected in printed publications and issued patents at the time of filing.

The present invention relates generally to the field of grooming devices, and more specifically, to an Artificial Intelligence (AI) enabled smart facial hair grooming device designed to groom, design, or shave facial hair automatically.

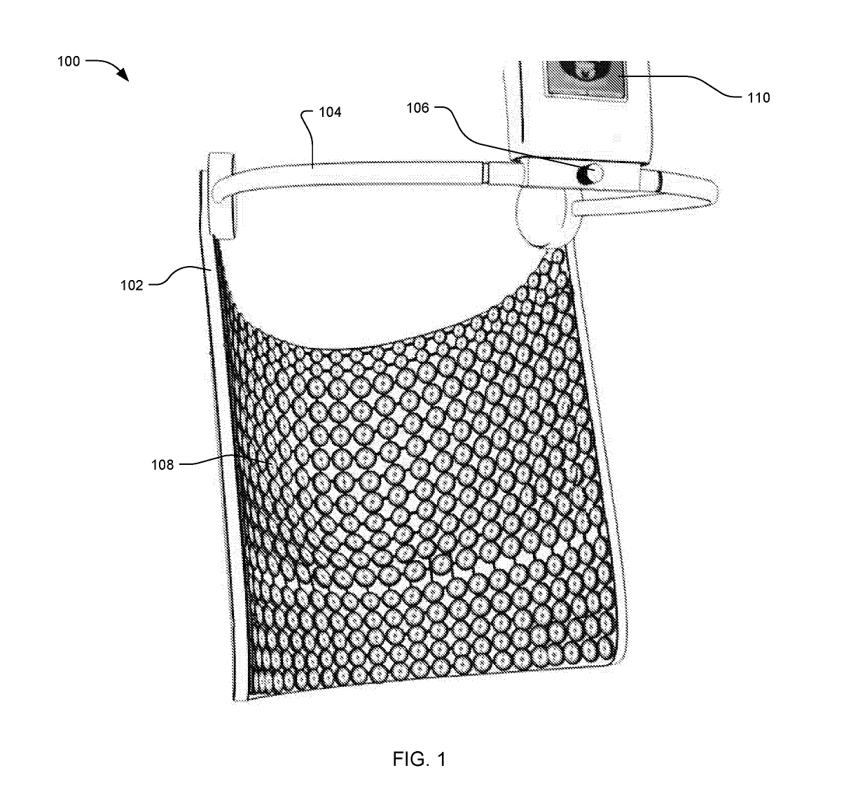

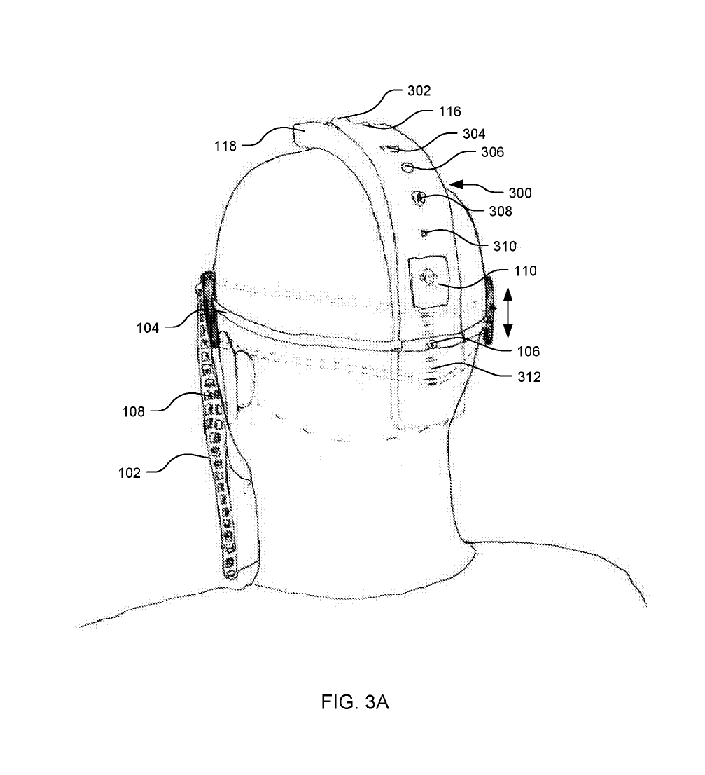

FIG. 1 illustrates an exemplary representation of proposed grooming device in accordance to an embodiment of the present disclosure. In an aspect, the grooming device 100 (also referred to as magic groomer hereinafter) can include a face shield 102 hingedly connected to a side adjustable frame 104, extension and retraction of the side adjusting frame 104 can be controlled and/or regulated by an adjusting knob 106. A user can shorten or lengthen the size adjustable frame 104 and secure it in place by tightening the adjusting knob 106 mounted on a rear portion (as clearly shown in FIG. 3) of the device 100.

In an aspect, the side adjustable frame 104 can include sliding means including, but not limited to, telescopic mechanism, sliding mechanism, and rack and pinion mechanism to allow one or more links to extend and retract from an original position. Further, retraction and extension of the one or more links of the side adjustable frame 104 allows the grooming device 100 to tightly fit head of a user. In an aspect, the face shield 102 and the side adjustable frame 104 can be made up of lightweight materials such as plastic or lightweight metal.

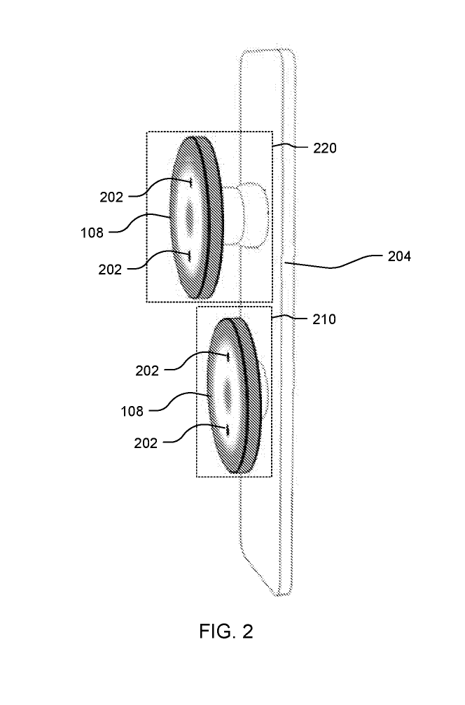

In an aspect, the device 100 can include a plurality of razors 108, each razor 108 including one or more nano-blades that have sharp edges to effect horizontal, vertical and angular cutting of facial hair of the user. The plurality of razors 108 can be mounted either on a movable platform or on a platform where the plurality of razors move in omni-direction either individually or in groups. Further, the plurality of razors 108 can move between an extended and a retracted position (as clearly illustrated in FIG. 2). In an aspect, one or more motors can be operatively coupled with the plurality of razors 108 to allow movement of the plurality of razors 108.

In an aspect, the device 100 can include at least one micro-controller (not shown) configured to control precise movement of the plurality of razors 108. The micro-controller can be connected to blade nose of each of the plurality of razors 108, and the micro-controller can enable magnetic levitation based movement of the plurality of razors 108.

In an aspect, the device can further include an Artificial Intelligence (AI) based pixel identifier (PI) module (not shown) configured to visualize a desired facial hair style on face of a user and program the micro-controller to move each of the plurality of razors 108 in a desired direction to allow cutting of facial hair of the user as per the desired facial hair style. The PI module can calculate movement points for the plurality of razors 108 to target, to enable pixel perfect movement of the plurality of razors 108, and the PI module detects facial hair shape, contours and hair pattern using AI algorithms and provides corresponding commands to the micro-controller to control movement of the plurality of razors 108.

In an aspect, the PI module can further process images drawn by a user or digital images of various beard styles and can provide the user with the convenience of taking a snapshot of a beard style drawn on a paper and transmit the snapshot to the grooming device 100 via data transfer means such as Bluetooth, WiFI, or direct transfer via USB port 304 of the grooming device (as clearly shown in FIG. 3A). The PI module automatically aligns design of the beard style and executes the required grooming, designing or shaving operation upon approval by the user after preview of the design.

In an aspect, the device 100 can include a touch screen cum display screen 110 that can display various facial hair styles to the user and provides execution of grooming, designing or shaving operation of the desired facial hair style selected by the user.

In an aspect, the device can be configured with any or a combination of one or more sensors, imaging devices, motion sensors and ultrasonic sensors to scan face of a user in real-time before actuating movement of the plurality of razors by the micro-controller, and to detect presence of hair within the face shield 102. In an exemplary implementation, an ultrasonic transducer and an ultrasonic receiver can be installed on either side of the face shield 102, wherein the transducer can transmit ultrasonic waves and the receiver can receive the ultrasonic waves, and presence of any foreign material such as hair within the face shield 102 can be detected.

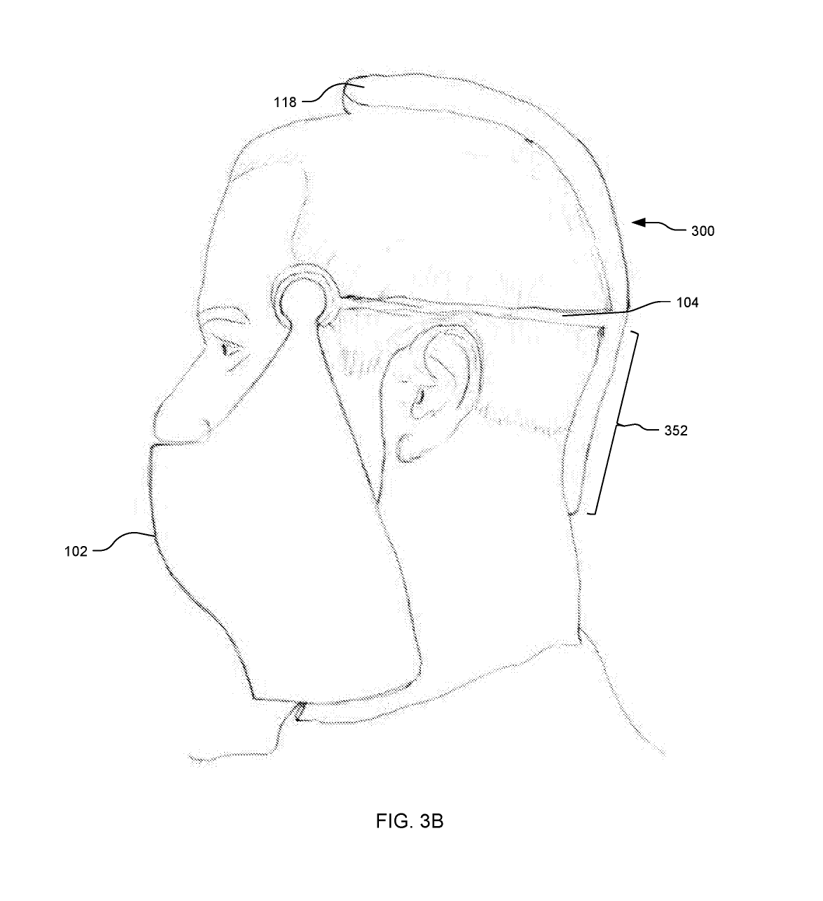

In an aspect, the device 100 can be configured with a default switch 116 (as clearly shown in FIG. 3) that can trigger the any or a combination of one or more sensors, imaging devices, motion sensors and ultrasonic sensors to detect presence of hair within the face shield 102. In an aspect, the device 100 can be powered by both AC and DC supply or by a rechargeable battery 118 (as clearly shown in FIG. 4A) that can be installed at a rear portion of the device 100. In an aspect, one touch of the default switch 116 can further enable a user to execute a clean shave operation if the user is not equipped with a mobile device or a computing device, and is unable to choose a desired beard style.

FIG. 2 illustrates an exemplary representation of retracted and extended position of a razor in accordance to an embodiment of the present disclosure. In an aspect, the plurality of razors 108 can be installed on a movable frame 204 of the face shield 102 to allow omni-directional movement of the plurality of razors 108 such that one or more nano-blades configured with the plurality of razors 108 can cut facial hair within the face shield 102. In an aspect, the plurality of razors 108 can be installed on a platform where the plurality of razors 108 can move omni-directionally either individually or in groups.

In an aspect, each of the plurality of razors 108 can include one or more hair sensors 202 that can detect the presence of hair in vicinity of each of the plurality of razors 108, and the razor 108 can move between a retracted position 210 and an extended position 220.

In an aspect, the plurality of razors 108 can remain at the retracted position 210 when the device 100 is not operational. However, once the device 100 is operational, and the one or more hair sensors 202 can detect the presence of facial hair of the user in the vicinity of the face shield 102, the plurality of razors 108 move to the extended position 220. In an aspect, grooming, designing or shaving of facial hair of the user is initiated when the plurality of razors 108 are in the expanded position 220.

In an aspect, movement of each of the plurality of razors 108 is actuated by magnetic levitation based movement enabled by the micro-controller. In an aspect, movement of the plurality of razors 108 from the retracted position 210 to the extended position 220 can be actuated by the one or more hair sensors 202 or by any or a combination of one or more sensors, imaging devices, motion sensors and ultrasonic sensors.

FIGS. 3A and 3B illustrates exemplary rear and side views of the proposed grooming device in accordance to an embodiment of the present disclosure. In an aspect, the device 100 includes a rear portion 300 that is either pivotally or fixedly connected to the size adjustable frame 104. In an aspect, one end of the rear portion 300 can be suspended freely such that it can freely adjust on head of the user. In an aspect, the rear portion 300 can include an ON/OFF button 302, a default switch 116, a USB port 304, a power adapter 306, a network toggle switch 308, an LED light 310 and a touch screen cum display screen 110.

In an aspect, the side adjustable frame 104 can be horizontally as well as vertically adjustable. Rear portion 300 can include an extended part 352 (as clearly shown in FIG. 3B) that extends vertically downwards and consists of a plurality of grooves 312 to allow vertical adjustment of the side adjustable frame 104 by operatively coupling the adjusting knob 106 with the plurality of grooves 312. In an aspect, a desired vertical height of the device 100 can be achieved by coupling the adjusting knob 106 with an appropriate groove 312 of the extended part 352 of the rear portion 300, and horizontal adjustment of the device 100 can be achieved by tightening or loosening the side supporting frame 104 in order to enable proper fitting of the device 100 with head of the user.

In an aspect, the ON/OFF button 302 can enable switching the device 100 ON or OFF. Pressing the ON/OFF switch 302 can either start the device 100 or can stop operation of the device 100. In an aspect, the default switch 116 can trigger any or a combination of one or more sensors, imaging devices, motion sensors and ultrasonic sensors to detect presence of hair within the face shield, and the USB port 304 can be used to transfer information/data to and from a computing device such as a mobile device, a personal laptop, a desktop, a tablet and the like without the requirement of a WiFi or Bluetooth network. In an aspect, the default switch can further enable a user to execute a clean shave operation if the user is not equipped with a mobile device or a computing device, and is unable to choose a desired beard style.

In an aspect, the power adapter 306 can enable charging of the rechargeable battery 118 and can also provide a connection of the device 100 to a power transmission cable that can provide AC/DC power supply to the device 100 such that the device can operate its intended function by directly utilizing AC/DC power supply of a power socket.

In an aspect, the network toggle switch 308 can enable the device 100 to connect to a WiFi enabled network or a Bluetooth enabled network such that a computing device can be connected to the device 100 and can control grooming, designing or shaving operation of the device 100. In an aspect, the LED light 310 can indicate various operations of the device 100 by illuminating various colours resembling to various operations. The LED light 310 can also provide for a means to determine charging status of removable battery 118 the device 100. In an aspect, the LED light 310 can illuminate a red light when the PI module of the device is visualizing desired facial hair style and can illuminate a green light when the visualization is processed.

In an aspect, the touch screen cum display screen 110 can display various facial hair styles to the user and provides execution of grooming, designing or shaving operation of the desired facial hair style selected by the user by providing the user with a selection menu to select a desired facial hair style form various facial hair styles. The touch screen cum display screen 110 can be an LED touch panel, an LCD touch panel and the like.

FIGS. 4A and 4B illustrate exemplary representation of the proposed grooming device installed on head of a user in an expanded state and a retracted state respectively in accordance to an embodiment of the present disclosure. In an aspect, the user can wear the grooming device 100 on his head by adjusting the adjusting knob 106 to enable tight fitting of the device 100 on head of the user. The side adjustable frame 104 can include sliding means including, but not limited to, telescopic mechanism, sliding mechanism, and rack and pinion mechanism to allow one or more links to extend and retract from an original position. Retraction and extension of the one or more links of the side adjustable frame 104 allows the grooming device 100 to tightly fit head of a user.

In an aspect, face shield 102 can be hingedly connected to the side adjustable frame 104 on both sides such that the face shield 102 can pivotally move between the retracted state 400 and the expanded state 450, wherein when the face shield 102 is in retracted state 400, the device 100 can perform grooming, designing or shaving operation and can effectively cut facial hair of the user. On the contrary, when the face shield 102 is in expanded state 450, the device 100 can be in a standby mode, wherein the device 100 is present at an elevated position in respect to the face of the user and thus, cannot provide for execution of grooming, designing or shaving operation and thus, cannot provide for cutting of facial hair of the user. In an aspect, in the retracted state, face shield 102 of the device 100 can be substantially parallel to face of the user and facial hair of the user is available in within the face shield 102.

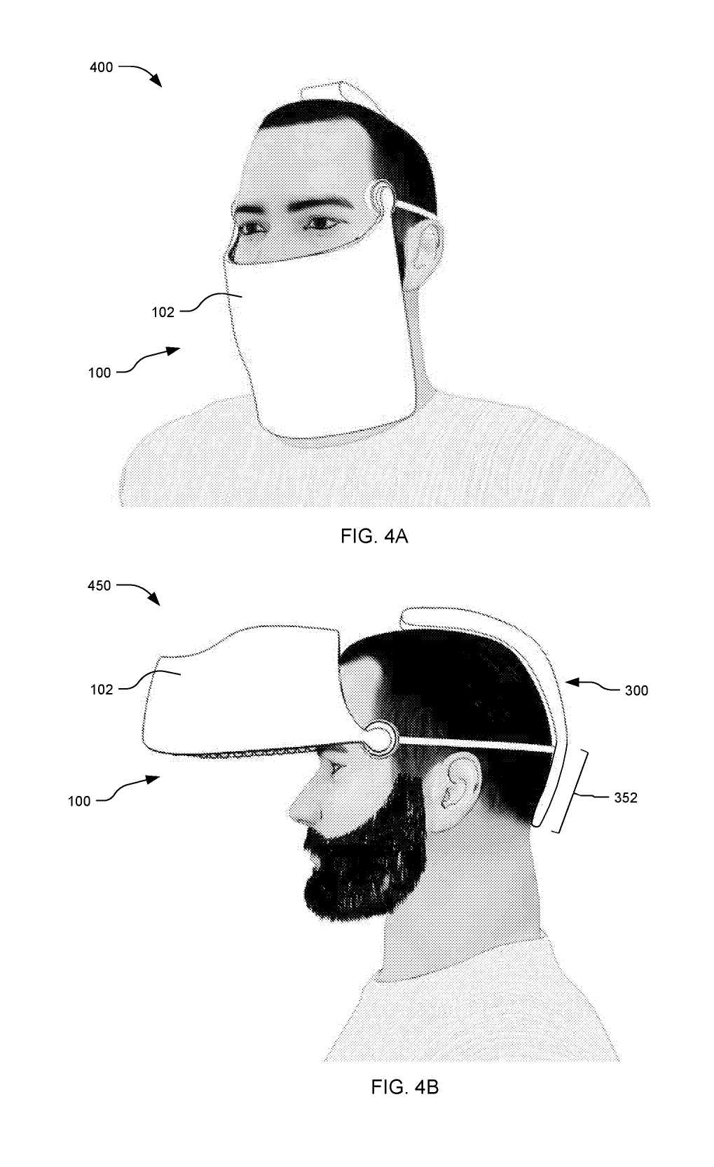

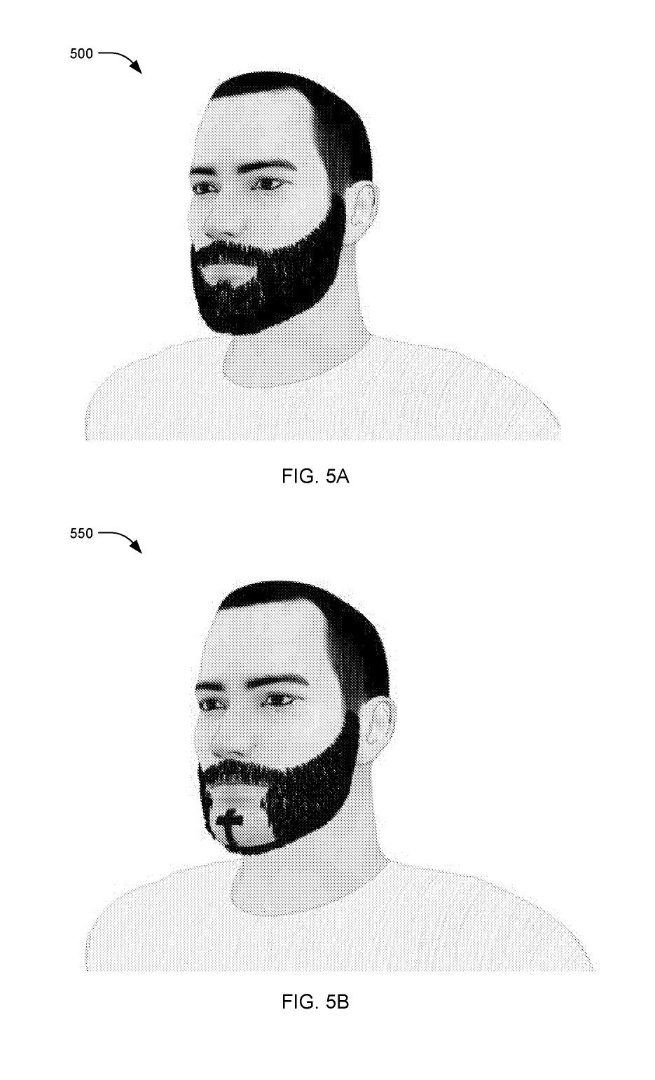

FIGS. 5A and 5B illustrate exemplary representation of unshaven beard of the user and shaven beard of the user using magic groomer respectively in accordance to an embodiment of the present disclosure. In an aspect, FIG. 5A illustrates a user having an unshaved beard 500, and FIG. 5B illustrates a user having a shaved beard 550 shaved by the grooming device 100.

In an aspect, Artificial Intelligence (AI) based pixel identifier (PI) module (not shown) can enable the device 100 to visualize a desired facial hair style on face of the user and program the micro-controller to move each of the plurality of razors 108 in a desired direction to allow cutting of facial hair of the user as per the desired facial hair style. The PI module can calculate movement points for the plurality of razors 108 to target, to enable pixel perfect movement of the plurality of razors 108, and the PI module detects facial hair shape, contours and hair pattern using AI algorithms and provides corresponding commands to the micro-controller to control movement of the plurality of razors 108.

In an aspect, to enable the unshaved beard 500 to be shaved as per the desired facial hair style chosen by the user, the user can put the grooming device 100 over his head and can adjust the adjusting knob 106 to enable tight fitting of the device 100 on head of the user. Thereafter, the user can either access the touch screen cum display screen 110 or can user a computing device such as a mobile device, tablet, a laptop, a desktop and the like to enable grooming, designing or shaving operation of the device 100.

In an aspect, a micro-controller can then use information provided by any or a combination of one or more sensors, imaging devices, motion sensors and ultrasonic sensors to detect presence of hair within the face shield 102, and can enable precise movement of the plurality of razors 108 to allow cutting of facial hair within the face shield 102.

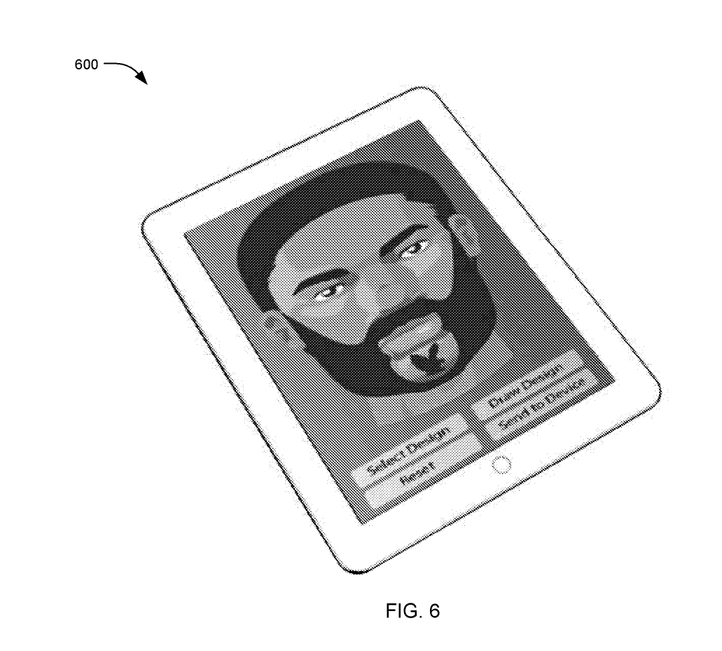

FIG. 6 illustrates an exemplary representation of a computing device configured to control the proposed grooming device in accordance to an embodiment of the present disclosure. In an aspect, a computing device 600 such as a tablet and the like can be configured to control the device 100. The computing device 600 can be installed with an application that can provide the user with a selection menu that includes various facial hair styles to select a desired facial hair style from the selection menu, and can further provide execution of grooming, designing or shaving operation of the device 100.

In an aspect, the computing device 600 can show the user a visualization of the desired facial hair style on face of the user, and upon confirmation by the user, the computing device can trigger the corresponding grooming, designing or shaving operation.

In an aspect, the computing device 600 can be connected to the device 100 via a wired connection by using the USB port 302 of the device 100 or via a wireless network such as Wifi, Bluetooth and the like.

In an aspect, the plurality of razors 108 can be covered with a metal mesh that can make it safe for people with pimples or saggy skin to use the grooming device 100. In another aspect, the at least one micro-controller can be configured such that it stops movement of the plurality of razors 108 in case when the grooming device 100 is shaking or is abruptly removed from head of the user or if face shield 102 is in expanded state 450. Further, movement of the plurality of razors 108 can continue once the grooming device 100 is operatively coupled with the head of the user and the ON/OFF switch 302 is pressed, after which a re-scan of facial contour and facial hair pattern of the user is carried out by the PI module, and remaining operation of the grooming device 100 can be accordingly completed.

In an aspect, in case of an electrical or mechanical malfunction, LED light 310 of the grooming device 100 can enable repeatedly blinking of a red light denoting that operation of the grooming device 100 is halted. The blinking of red light can stop once the malfunction is rectified and the grooming device 100 can continue its operation thereafter.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

### ADVANTAGES OF THE INVENTION

The present disclosure provides an Artificial Intelligence (AI) enabled grooming device.

The present disclosure provides a grooming device that is safe, easy to operate and provides convenience to a user to select a desirable facial hair style from various facial hair styles.

The present disclosure provides a grooming device that can be efficiently used by crippled, elderly, or incapacitated.

The present disclosure provides a grooming device that can groom, design or shave complex facial hair pattern.

The present disclosure provides a grooming device that is water-resistant.

The present disclosure provides a grooming device that can be controlled by a mobile device or a host computer.

The present disclosure provides a grooming device that can enable grooming, designing or shaving of facial hair based on user's preference.

The present disclosure provides a grooming device that can create various facial hair styles for men in a short time interval.

The present disclosure provides a grooming device that is easy to use.

The present disclosure provides a grooming device that provides precise grooming or designing operations.

I claim:

1. A grooming device capable of grooming, designing or shaving facial hair of a user, the grooming device comprising:
a face shield configured with a plurality of razors installed on at least one inner surface of the face shield;
at least one micro-controller configured to control movement of the plurality of razors; and
an Artificial Intelligence (AI) based pixel identifier (PI) module configured to visualize a desired facial hair style on face of the user and program the micro-controller to move each of the plurality of razors in a desired direction to allow cutting of facial hair of the user as per the desired facial hair style.

2. The device of claim 1, wherein said plurality of razors have three dimensional moving ability and each of said plurality of razors comprise one or more nano-blades that have sharp edges to effect horizontal, vertical and angular cutting.

3. The device of claim 1, wherein the at least one micro-controller enables magnetic levitation based movement or motor driven movement of the plurality of razors.

4. The device of claim 1, wherein the PI module is configured to calculate movement points for the plurality of razors to target, to enable pixel perfect movement of the plurality of razors.

5. The device of claim 1, wherein the PI module detects facial hair shape, contours and hair pattern using AI algorithms and provides corresponding commands to the micro-controller to control movement of the plurality of razors.

6. The device of claim 1, wherein the at least one micro-controller is connected to blade nose of each of the plurality of razors.

7. The device of claim 1, wherein the device comprises a size adjustable frame that is hingedly connected to the face shield.

8. The device of claim 7, wherein the device comprises an adjusting knob that adjusts the size adjustable frame to enable proper fitting of the device on head of the user.

9. The device of claim 1, wherein the plurality of razors are mounted either on a movable platform or on a platform where the plurality of razors move omni-directionally either individually or in groups.

10. The device of claim 1, wherein the device comprises any or a combination of one or more sensors, imaging devices, motion sensors and ultrasonic sensors.

11. The device of claim 1, wherein the device is controlled by a computing device.

12. The device of claim 1, wherein the device is configured with a default switch that triggers any or a combination of one or more sensors, imaging devices, motion sensors and ultrasonic sensors to detect presence of hair within the face shield, and further executes a clean shave operation.

13. The device of claim 1, wherein the device comprises a touch screen that displays various facial hair styles to the user and provides execution of grooming, designing or shaving operation of the desired style selected by the user.
